(19) United States
(12) Patent Application Publication
(10) Pub. No.: US 2008/0108033 A1
(43) Pub. Date: May 8, 2008

(54) Interactive Video Monitor in the Surgical Suite's Preparation Areas for Educational Purposes

(76) Inventor: Lanny L Johnson, Okemos, MI (US)

Correspondence Address: WILSON DANIEL SWAYZE, JR., 3804 CLEARWATER CT., PLANO, TX, 75025, US

(21) Appl. No.: 11/551,862

(22) Filed: Oct. 23, 2006

(51) Int. Cl. G09B 23/28

(52) U.S. Cl. 434/262

(57) ABSTRACT

An apparatus for viewing information includes a wireless interactive monitor including a screen for displaying the information and adapted to receive the information wirelessly and a surgeon scrub sink for allowing a surgeon to sterilize the hands of the surgeon, positioned under the wireless interactive monitor.

### FIELD OF INVENTION

The present invention is directed generally to an Internet based wireless or wired communication device, and more particularly, to a system and method for maintaining a video image for interactive communication at areas in the surgical suite of a hospital or clinic to transmit educational instruction of pertinent and timely information for the medical profession. In one embodiment, the device would be in the surgical suite located above the surgical scrub sinks.

### BACKGROUND OF THE INVENTION

Due to recent federal legislation as well as new educational institutional policies, pharmaceutical and medical device companies are banned from providing any significant financial assistance or incentive to the doctors or the medical staff in order to promote their products or services. Traditional marketing methods included use of company employees to entertain, gift, or otherwise incentive medical personnel to listen to or see presentations concerning the respective companies products or services. In response to the loss of this traditional method, the medical companies have taken to marketing their products directly to the public via commercial media, i.e television, magazines, newspapers. The thrust of such marketing is to motivate the potential patient to ask their doctor about the product. Often this is the first notification of such a product. It is no longer the direct relationship with the supplier for information, but it is the patient who is now the agent of information. This method often is confusing to the patient who may lack medical understanding and novel to the physician or staff who was not prepared educationally to respond to the patient's inquiry. The problem now is how to get this timely educational information to the medical profession. Continuing medical education is provided by the hospitals, universities, and medical societies, but these are monthly or less frequent.

This problem is further complicated by the doctor's and staff's available time being limited. Daily patient care activities minimize or eliminate daily education opportunity. There is little time available on a daily basis to learn about the new products or services of the pharmaceutical or medical device companies for the above reasons.

However, prior to an operation, surgeons and staff spend a significant amount of total time washing his/her hands and forearms, even multiple times each day. The period of time “scrubbing” is typically three to ten minutes at a surgical scrub sink. Surgical sinks are used in order to permit a surgeon to wash his/her hands prior to entering the surgical suite and subsequent placement of the sterile surgical gloves for surgery. Furthermore, the surgical sinks are located in or near the operating room and consequently may be difficult to hard wire. It is essential in order to maintain the sterile conditions that the surgeon's hands not touch any object which might be unsterile. It is a time of isolation from any and all other activities. Voice activation is possible for selection from the menu on the television monitor for the program of their choosing; by their specialty or their academic interest. Therefore this is an opportune time for short segments of video and or sound bites concerning relevant medical educational material. The same system may be used for in service educational training of the support staff on new procedures, medications or instrumentation.

### SUMMARY OF THE INVENTION

An object of this invention is to provide an automatically operated monitor and surgical scrub sink which overcomes the above disadvantages.

A further object of this invention is to provide such a surgical scrub sink and wireless interactive monitor which can be wirelessly or wire connected to an information source which includes pharmaceutical or other types of information which would be useful for the surgeon. Consequently, while the surgeon is cleaning his hands, he can activate the wireless interactive monitor in order to obtain additional information such as pharmaceutical information.

Wireless communications devices, such as the monitor and the cell phone, typically include a housing and various data input and output devices, such as a keyboard, a display, a microphone and a speaker. In addition, some wireless communications devices have video conferencing capabilities.

In accordance with this invention, a surgical scrub sink and wireless interactive monitor is positioned over the sink. An electronically operated on/off mechanism controls the wireless interactive monitor positioned above the scrub sink. The wireless interactive monitor may be voice activated and controlled so that the surgeon does not need to physically touch the monitor. The interactive monitor may include a computer in order to perform the voice activation of the interactive monitor and to perform the voice control of the interactive monitor. A sensor may be mounted under or alongside the tub for directing a beam in front of the tub at the height of the user's legs so as to detect the presence and absence of a user in the immediate vicinity of the tub. The sensor is operationally connected to the on/off mechanism so as to comprise a control for turning on the monitor when the presence of the user is detected and turning off the monitor when the absence of a user is detected. The sensor provides an alternative to voice activation.

The sensor may only be operative only over a focal distance of two to six inches so as to avoid false starts by detecting objects other than the surgeon standing in the immediate vicinity of the tub. A further preferred practice of the invention provides mounting the sensor on a support arm which extends below and generally to the front edge of the tub so as to assure properly locating the short focus sensor at its desired location. The support arm may be suspended from the tub by mounting the support arm to the tub drain pipe. The support arm may be used for mounting the mixing valve for the faucet.

### BRIEF DESCRIPTION OF THE DRAWING

The invention may be understood by reference to the following description taken in conjunction with the accompanying drawings, in which, like reference numerals identify like elements, and in which:

FIG. 1 illustrates a computer diagram of the video output device of the present invention;

FIG. 2 illustrates the video output device and the wireless interactive monitor of the present invention;

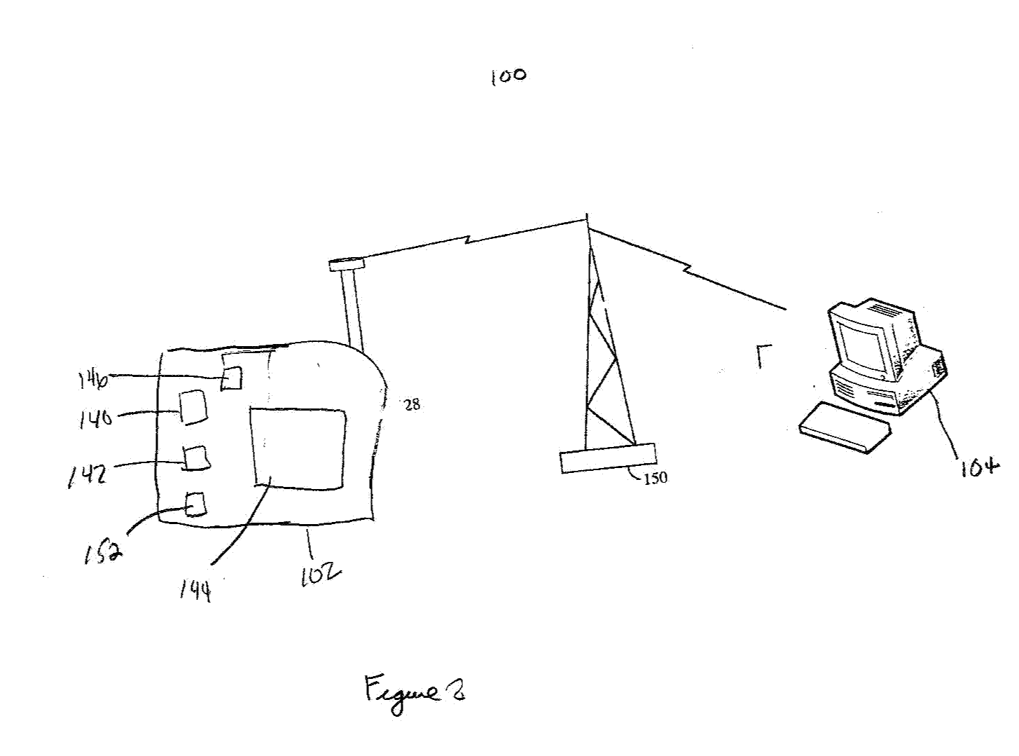

FIG. 3 illustrates a front view of the wireless interactive monitor and surgeon sink of the present invention;

FIG. 4 illustrates a side view of the wireless interactive monitor and the surgeon sink of the present invention.

### DETAILED DESCRIPTION

The present invention involves improvements over surgical scrub sinks utilizing automatic control apparatus for turning the wireless interactive monitor on and off. Of the present invention is described in terms of a wireless device, the principles of the present invention can be equally applied to a wired system including a wired interactive monitor.

The concepts of the invention may be practiced with various types of known surgical scrub sinks wherein the invention is incorporated therein by providing a sensor mounted at a location which would generally correspond to the legs, and more particularly the knee area, at the immediate vicinity of the sink tub. Preferably, the sensor is of short focus with a focal distance of about 2-6 inches, so as to avoid false signals which would otherwise be caused by detecting objects other than the user of the sink. The invention is based upon the recognition that when the user of the sink, such as a surgeon, is performing a hand scrubbing operation, he or she will stand immediately juxtaposed to the sink tub during the scrubbing or hand washing operation and will remain in that position until the scrubbing operation is completed, although during the scrubbing operation there might be periods of time when the hands are not in the immediate vicinity of the faucet. During this period of time, the surgeon is free to view the material presented on the interactive wireless monitor. Thus, the present invention could rely upon detection of the hands near the faucet as well as the detection of the legs near the tub. The monitor 102 which may shut itself off after a predetermined amount of time or could be shut off by voice-activated command. Although the present invention is described in terms of the interactive monitor 102 positioned above a scrub sink 10 other locations within the surgical suite are within the scope of the present invention. For example, the interactive monitor 102 could be positioned to the left of or to the right of the scrub sink 10. Furthermore, the present invention describes the user of the interactive monitor 102 and a scrub sink 10 as a surgeon, but other users such as nurses and assistants could take advantage of the interactive monitor 102. The scrub sink 10 could be found in the preparation area and could be used to clean surgical instruments between cases. Individuals who are not familiar with the various instruments could use the interactive monitor 102 for tutorials which is sometimes called in-service education. The interactive monitor 102 could be positioned in a doctors or nurses lounge and might be used with earphones.

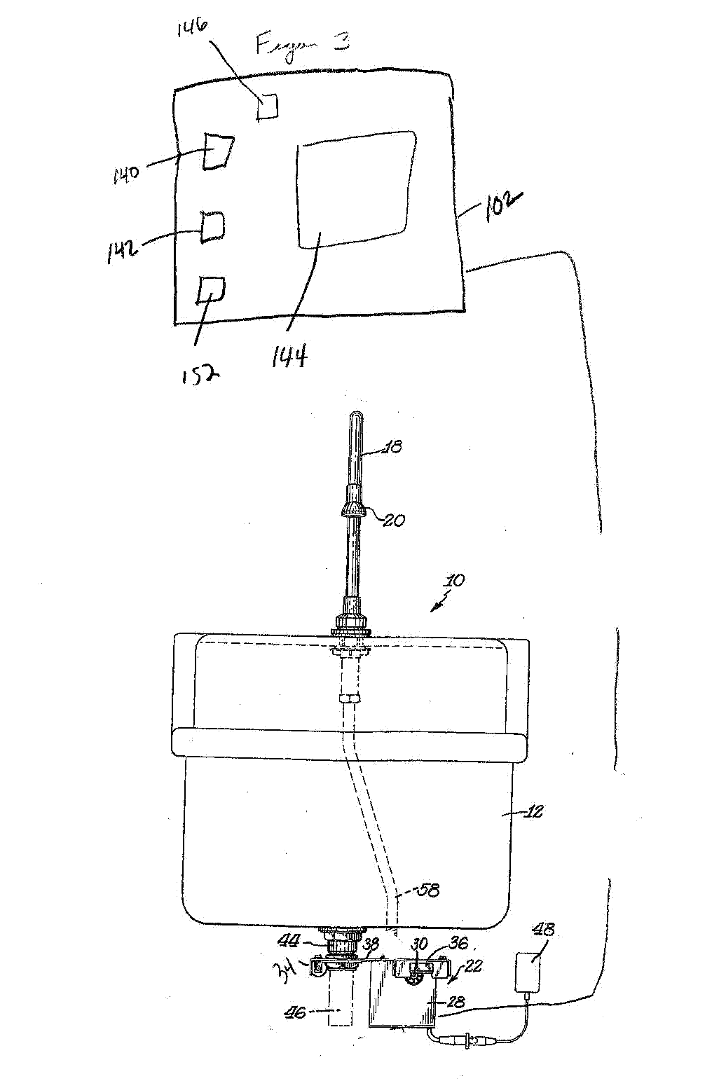

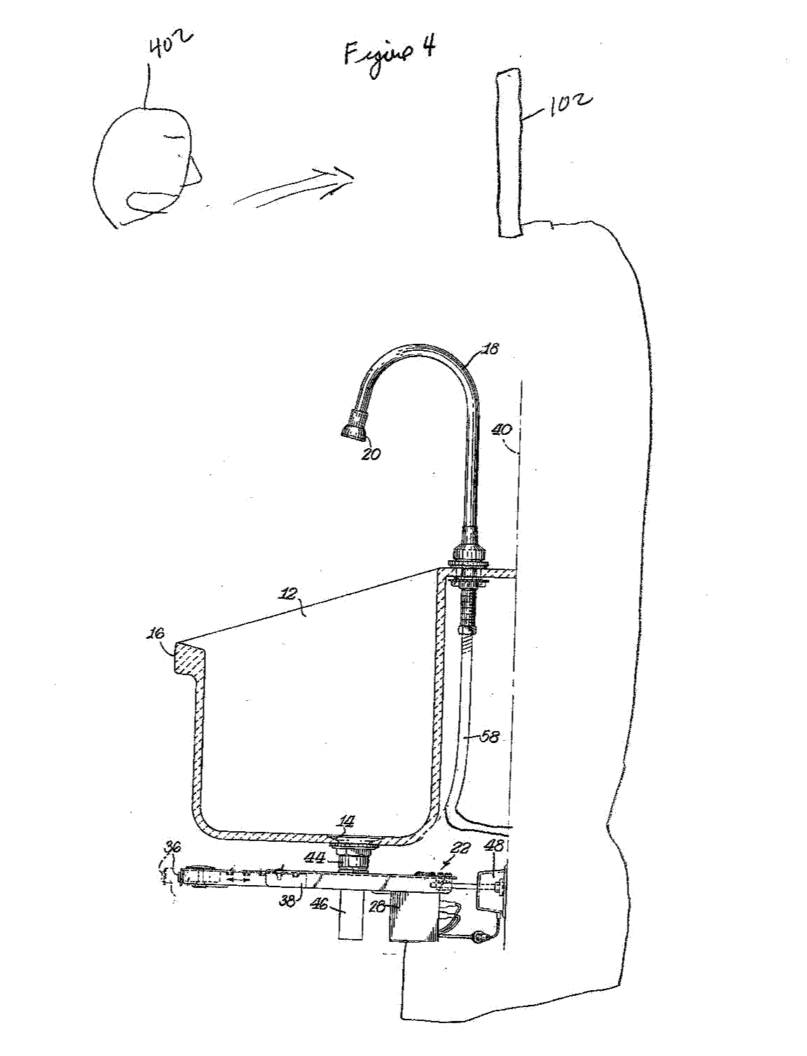

As illustrated herein and in FIGS. 3-4, a surgical scrub sink 10 is shown which includes a tub 12 of any suitable known description and wireless interactive monitor 102. The tub 12 would include a drain hole 14 at its lower portion and would include a front edge 16. A faucet 18 is mounted at the top of tub 12. The faucet 18 terminates in a nozzle 20 which is disposed over and toward the open body of tub 12.

The wireless interactive monitor 102 is electronically operated by an on/off mechanism 22 as described above or the wireless interactive monitor 102 could be voice-activated by user 402. Such on/off mechanism 22 may include, for example, a solenoid controlled electronic switch in order to turn on and off the electric power for the wireless interactive monitor 102 in housing 28. A sensor module cable 30 is also provided in housing 28.

The housing or enclosure 28 for the on/off mechanism 22 is mounted to a support arm 34. A sensor 36 is mounted to the remote or free end of support arm 34 as best shown in FIGS. 3-4.

Support arm 34 includes a main bracket 38 which is fixedly mounted to any suitable support. For example, as best illustrated in FIG. 3 the main bracket 38 is attached to drain tube 44 of tub 12 and is stabilized against rotation by a pair of wall adjustment screws bearing against wall 40. Tub 12 is secured directly to wall 40.

Advantageously, support arm 34 is utilized for mounting various components of the surgical scrub sink 10. As noted, sensor 36 and on/off mechanism 22 are mounted to support arm 34. Support arm 34 is suspended from tub 12 by connection to drain tube 44 leading from drain hole 14. Tube 44 is mounted to and through support arm 34 with the tail piece 46 extending downwardly below support arm 34. As illustrated in the various figures, the on/off mechanism 22 includes a transformer 48 mounted at any suitable location, such as to wall 40. The wiring for transformer 48 is electrically connected to the wiring from on/off mechanism 22. The on/off mechanism also includes a wire to connect to wireless interactive monitor 102. Transformer 48 may be of any suitable known construction such as a 12 volt transformer.

Sensor cable 30 is housed within the downwardly extending sides of arm 34 and is connected to sensor 36. The position of sensor module 36 could be adjusted to its intended location with respect to the front edge 16 of tub 12. This assures that the module will detect the presence or absence of the user standing in front of and at or juxtaposed to front edge 16 of tub 12.

Accordingly, it is possible to use a short focus sensor having an effective focal distance of about 2-6 inches and still reliably sense the presence or absence of a surgeon standing at sink 10. The elevation of sensor 36 above the floor would be selected to correspond to the elevation of the surgeon's legs, such as in the knee area. Other locations of the surgeon's legs could also be used as the detecting target. Thus, sensor module 36 could be elevated above the floor any suitable distance of, for example, six inches to thirty inches.

The invention would thus be practiced by suitably positioning sensor module 36 at the desired location, generally at the front edge 16 of tub 12. Sensor module 36 would project a beam which operates to detect the presence or absence of an object in the range of the beam. Because sensor module 36 preferably operates with a focus, the presence of an object would be detected only when the object is in the immediate vicinity of front edge 16 at the elevation of sensor module 36. Thus, under ordinary conditions no object would be detected. This detection of the absence of an object would permit the on/off mechanism 22 to remain in its off condition and the wireless interactive monitor 102 would remain off. When, however, a surgeon steps to sink 10 in order to perform a scrubbing operation by standing at the front edge 16 of sink 10, sensor module 36 would detect the presence of an object, namely the surgeon's legs and the sensing would be transmitted to on/off mechanism 22 and permit the wireless interactive monitor 102 to be activated. The wireless interactive monitor 102 would remain the on as long as the surgeon remained at the front of tub 12. Once the scrubbing operation has been completed the surgeon would step away from tub 12. Sensor 36 would then detect the absence of the surgeon and corresponding signal would be sent to the on/off mechanism 22. The wireless interactive monitor 112 would then shut off.

An optional manual override switch is also provided to facilitate continued operation of the wireless interactive monitor 102 should there be an interruption in power to the mechanism 22. This override switch is linked to a backup battery power pack to maintain actuation of the on/off mechasism 22, and resultant operation of the wireless interactive monitor 102 in case of a power failure.

The invention thus provides a way of automatically controlling the wireless interactive monitor 102 during scrubbing which permits full movement of the surgeon's arms and hands during the scrubbing without affecting the operation of the wireless interactive monitor 102. The wireless interactive monitor 102 shuts off once is completed and the surgeon is no longer present at sink 10.

The wireless interactive monitor 102 of the present invention receives a video image provided by a video-output device 104 of a wireless communications device, and as a result enables a surgeon of the wireless communications device to receive information in the form of video and audio and to provide feedback to the video-output device 104 in order to instruct the video-output device 104 which information that the surgeon would like to see and hear. The feedback would allow the surgeon take appropriate action to maintain or adjust the content of the video image. The present invention may be readily implemented in any wireless communication device. Although the examples presented herein refer to a video monitor 102 but could be extended to a cellular phone, the principles of the present invention are applicable to any wireless communication device, including, but not limited to, analog and digital cellular telephones, personal communications system (PCS) devices, and the like.

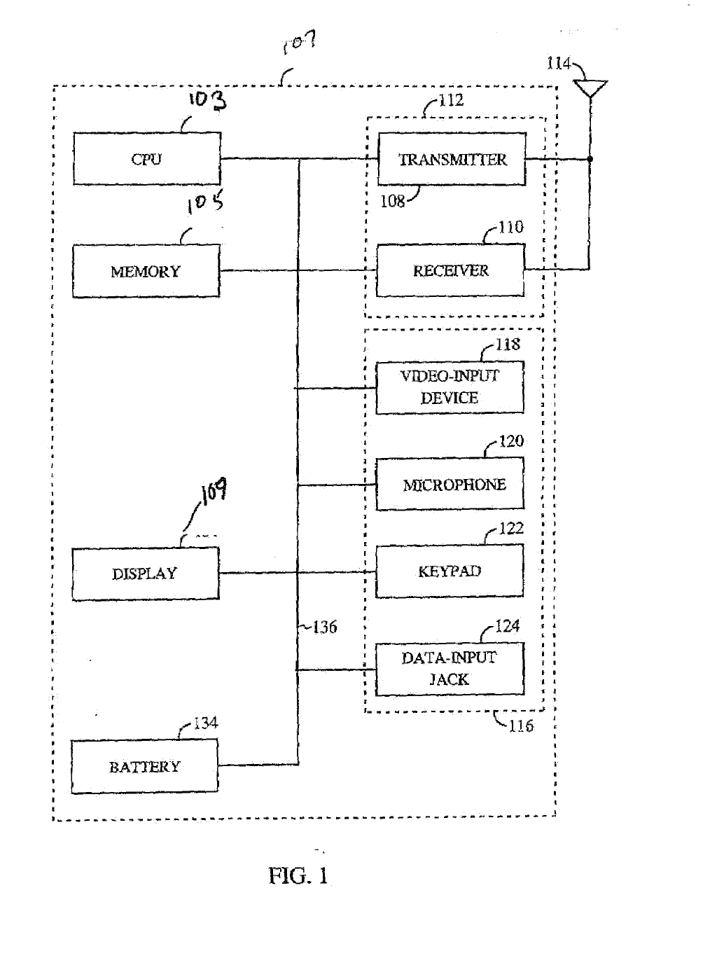

The present invention is embodied in a system 100 illustrated in the functional block of FIG. 1. The system 100 includes a central processing unit (CPU) 103, which controls operation of the system. A memory 105, which may include both read-only memory (ROM) and random-access memories (RAM), provides instructions and data to the CPU 103. A portion of the memory 105 may also include non-volatile random-access memory. The display 109 provides a screen for CPU 103.

The system 100, which is typically embodied in a wireless communication device, also includes a housing 107 that contains a transmitter 108 and a receiver 110 to allow transmission and reception of data, such as audio and video communications and programming data, between the system 100 and a remote location, such as the monitor 102 or the like. The transmitter 108 and the receiver 110 may be combined into a transceiver 112. The transmitter 108 and receiver 110 may be connected to transmit and receive wireless Internet. An antenna 114 is attached to the housing 106 and electrically coupled to the transceiver 112. Although FIG. 1 illustrates the antenna 114 as extending from the housing 107, some designs may include an internal antenna that is contained completely within the housing. FIG. 1 illustrates a tower 150 which may be located at the hospital or some other convenient location to connect the wireless signal to the video output device 104. The wireless signal may be a wireless Internet signal.

A user-input device 116, comprising at least a video-input device 118, is communicatively linked to the system 100 for operation by the user in a conventional manner. The user-input device 116 provides a convenient way which audio, commands, video images, voice data and other data may be entered by the user. Although FIG. 1 illustrates the user-input device 116 as comprising a video-input device 118 to input video for example from the medical companies to be ultimately displayed on the monitor 102, a microphone 120, a keypad 122, and a data-input jack 124 for example to connect to the Internet so that video and other data can be obtained and contained within the housing 106, other user input devices may be used, such as the receiver, and the like, and in various combinations. In addition, while the video-input device 118 may be a camera or tape, video-input devices 118 may be used, including the data-input jack 124, the receiver 110, and the like, and in various combinations.

Electrical components of the system 100 receive power from a battery 134, which is attached to and supported by the housing 106. In an exemplary embodiment, the battery 134 is a rechargeable battery. In other embodiments, the system 100 may include a connector (not shown) for the connection of an external power source, such as an automobile power adapter, AC power adapter, or the like.

The various components of the system 100 are coupled together by a bus system 136 which may include a power bus, control bus, and status signal bus in addition to a data bus. For the sake of clarity, however, the various buses are illustrated in FIG. 1 as the bus system 136.

FIG. 3 illustrates the operation of the system 100 to transmit the video image and audio to a remote location, such as the wireless interactive monitor 102. The video image and audio may be transmitted to a variety of remote locations, such as another system 100, or the like. For the sake of brevity, the system 100 will be described using a limited number of examples.

In operation, the sensor 36 senses the presence of the surgeon at the surgical scrub sink 10 and activates the on/off mechanism 22 to its on condition. The on/off mechanism 22 activates the wireless interactive monitor 102. Initially, a first menu 140 and a second menu 142 appear on the screen 144 of the wireless interactive monitor 102 which may be a screen for a computer monitor or a screen for a television set. The surgeon may start the wireless interactive monitor 102 by a voice command using the voice recognition technology 152. The surgeon chooses either the first menu 140 or the second menu 142 by either touching the screen of the wireless interactive monitor 102 at the appropriate first menu 140 or the second menu 142 or using voice recognition technology 152 of the monitor 102, the surgeon speaks his choice for the first menu 140 or the second menu 142 which is received by the voice-recognition technology 152 to activate the first menu 140 choice or the second menu 142 choice. Either the first menu 140 choice or the second menu 142 choice is wirelessly sent to the video-output device 104 as feedback. The feedback is received by the antenna 114 and transmitted to the receiver 110 which transmits the feedback to the CPU 103. The CPU 103 uses the feedback to select audio and video, only audio or only video from the memory 105. Using audio and video as an example, the CPU 103 directs the audio and video to the transmitter 108, and the transmitter 108 transmits the audio and video to the antenna 114 which in turn is wirelessly transmitted to the wireless interactive monitor 102 to be received and played on the screen of the wireless interactive monitor 102. This continues until the audio or video transmitted from the transmitter 108 ends or the surgeon walks away from the surgical scrub sink 10 at which point the sensor 36 fails to detect the surgeon standing in front of the surgical scrub sink 10. The sensor 36 directs the on/off mechanism 22 to turn off the wireless interactive monitor 102, and the on/off mechanism 22 turns off the wireless interactive monitor 102. A voice command could be used to turn off the wireless interactive monitor 102 by utilizing the speech recognition technology 152.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An apparatus for viewing information, comprising:
a wireless interactive monitor including a screen for displaying said information and adapted to receive said information wirelessly;
a surgeon scrub sink for allowing a surgeon and/or hospital personnel to sterilize the hands of the surgeon, positioned under said wireless interactive monitor.

2. An apparatus for viewing information as in claim 1, wherein said information is received from a video-output device.

3. An apparatus for viewing information as in claim 1, wherein said information is associated with medical, surgical and pharmaceutical information.

4. An apparatus for viewing information as in claim 1, wherein said wireless interactive monitor response to voice commands.

5. An apparatus for viewing information as in claim 1, wherein said wireless interactive monitor displays a menu to select video.

6. An apparatus for viewing information as in claim 1, wherein said wireless interactive monitor displays a menu to select audio.

7. An apparatus for viewing information as in claim 1, wherein said wireless interactive monitor displays a menu to select video and audio.

8. An apparatus for viewing information as in claim 1, wherein said surgeon scrub sink detects the presence or absence of the user.

9. An apparatus for viewing information as in claim 8, wherein said surgeon scrub sink activates said wireless interactive monitor when a user is present.

10. An apparatus for viewing information as in claim 8, wherein said surgeon scrub sink shuts off said wireless interactive monitor when the user is not present.

11. An system for viewing information, comprising:
a wireless interactive monitor including a screen for displaying said information and adapted to receive said information wirelessly;
a surgeon scrub sink for allowing a surgeon to sterilize the hands of the surgeon, positioned under said wireless interactive monitor.

12. An system for viewing information as in claim 11, wherein said information is received from a video-output device.

13. An system for viewing information as in claim 11, wherein said information is associated with pharmaceutical information.

14. An system for viewing information as in claim 11, wherein said wireless interactive monitor response to voice commands.

15. An system for viewing information as in claim 11, wherein said wireless interactive monitor displays a menu to select video.

16. An system for viewing information as in claim 11, wherein said wireless interactive monitor displays a menu to select audio.

17. An system for viewing information as in claim 11, wherein said wireless interactive monitor displays a menu to select video and audio.

18. An system for viewing information as in claim 11, wherein said surgeon scrub sink detects the presence or absence of the user.

19. An system for viewing information as in claim 18, wherein said surgeon scrub sink activates said wireless interactive monitor when a user is present.

20. An system for viewing information as in claim 18, wherein said surgeon scrub sink shuts off said wireless interactive monitor when the user is not present.
